(19) United States
(12) Patent Application Publication
(10) Pub. No.: US 2004/0175056 A1
(43) Pub. Date: Sep. 9, 2004

(54) Methods and systems for objective measurement of video quality

(76) Inventor: Chulhee Lee, Goyang-City (KR)

Correspondence Address: Chulhee Lee, Dongbu-Apt 509-204, Jooyeob-Dong 47, Ilsan-Gu, Goyang-city, 411-744, KR

(21) Appl. No.: 10/382,377

(22) Filed: Mar. 7, 2003

(51) Int. Cl. G06K 9/36; G06K 9/48; H04N 17/00

(52) U.S. Cl. 382/286; 382/199; 348/180

(57) ABSTRACT

New methods and systems for objective measurements of video quality based on degradation of edge areas are provided. By observing that the human visual system is sensitive to degradation around edges, objective video quality measurement methods that measure degradation around edges are provided. In the present invention, an edge detection algorithm is first applied to the source video sequence to find edge areas. Then, the degradation of those edge areas is measured by computing a difference between the source video sequence and a processed video sequence. From this mean squared error, the PSNR is computed and used as video quality metric.

### BACKGROUND OF THE INVENTION

1. Field of the Invention

This invention relates to methods and systems for objective measurement of video quality.

2. Description of the Related Art

Traditionally, the evaluation of video quality is performed by a number of evaluators who subjectively evaluate the quality of video. The evaluation can be done with or without reference videos. In referenced evaluation, evaluators are shown two videos: the reference (source) video and the processed video that is to be compared with the source video. By comparing the two videos, the evaluators give subjective scores to the videos. Therefore, it is often called a subjective test of video quality. Although the subjective test is considered to be the most accurate method since it reflects human perception, it has several limitations. First of all, it requires a number of evaluators. Thus, it is time-consuming and expensive. Furthermore, it cannot be done in real time. As a result, there has been a great interest in developing objective methods for video quality measurement. Typically, the effectiveness of an objective method is measured in terms of correlation with the subjective test scores. In other words, the objective method, which provides test scores that most closely match the subjective scores, is considered to be the best. Another important requirement for an objective method for video quality measurement is that it should provide consistent performances over a wide range of video sequences that are not used in the design stage.

In the present invention, new methods and systems for objective measurement of video quality are provided based on edge degradation. It is observed that the human visual system is sensitive to degradation around the edges of images. In other words, when edge areas of a video are blurred, evaluators tend to give low scores to the video even though the overall mean squared error is small.

### SUMMARY OF THE INVENTION

Therefore, it is an object of the present invention to provide new methods and systems for objective measurement of video quality based on degradations of the edge areas of videos.

It is another object of the present invention to provide new methods and systems for objective measurement of video quality, which provide consistent performances over a wide range of video sequences that are not used in design stage.

The other objects, features and advantages of the present invention will be apparent from the following detailed description.

### BRIEF DESCRIPTION OF THE DRAWING

FIG. 1 shows a source image (original image).

FIG. 2 shows a horizontal gradient image, which is obtained by applying a horizontal gradient operator to the source image of FIG. 1.

FIG. 3 shows a vertical gradient image, which is obtained by applying a vertical gradient operator to the source image of FIG. 1.

FIG. 4 shows a magnitude gradient image.

FIG. 5 shows the binary edge image (mask image) obtained by applying thresholding to the magnitude gradient image of FIG. 4.

FIG. 6 shows a vertical gradient image, which is obtained by applying a vertical gradient operator to the source image of FIG. 1.

FIG. 7 shows a modified successive gradient image (horizontal and vertical gradient image), which is obtained by applying a horizontal gradient operator to the vertical gradient image of FIG. 6.

FIG. 8 shows a binary edge image (mask image) obtained by applying thresholding to the modified successive gradient image of FIG. 7.

FIG. 9 shows a block diagram of the present invention.

FIG. 10 illustrates a system that measures the video quality of a processed video.

### DESCRIPTION OF THE ILLUSTRATED EMBODIMENTS

Embodiment 1

The present invention for objective video quality measurement is a full reference method. In other words, it is assumed that a reference video is provided. In general, a video can be understood as a sequence of frames or fields. Since the present invention can be used for field-based videos or frame-based videos, the terminology “image” will be used to indicate a field or frame. One of the simplest ways to measure the quality of a processed video sequence is to compute the mean squared error (MSE) between the source and processed video sequences as follows:

$${e}_{mse} = \frac{1}{LMN} {\sum }_{l} {\sum }_{m} {\sum }_{n} {( U ( l , m , n ) - V ( l , m , n ) )}^{2}$$

where U represents the source video and V the processed video sequence. M is the number of pixels in a row, N is the number of pixels in a column, and L is the number of the frames. The PSNR is computed as follows:

$$PSNR = 10 {log}_{10} ( \frac{{P}^{2}}{{e}_{mse}} ) \qquad ( 3 )$$

where P is the peak pixel value. However, it has been reported that the PSNR (Peak Signal-to-Noise Ratio) or MSE does not accurately represent human perception of video quality.

By analyzing how humans perceive video quality, it is observed that the human visual system is sensitive to degradation around the edges. In other words, when the edge areas of a video are blurred, evaluators tend to give low scores to the video even though the overall mean squared error is small. It is further observed that video compression algorithms tend to produce more artifacts around edge areas. Based on this observation, the present invention provides an objective video quality measurement method that measures degradation around the edges. According to the teaching and idea of the present invention, an edge detection algorithm is first applied to the source video sequence to locate the edge areas. Then, the degradation of those edge areas is measured by computing the mean squared error. From this mean squared error, the PSNR is computed and used as a video quality metric.

According to the teaching and idea of the present invention, an edge detection algorithm needs to be first applied to find edge areas. One can use any kind of edge detection algorithm, though there may be minor differences in the results. For example, one can use any gradient operator to find edge areas. A number of gradient operators have been proposed [1]. In many edge detection algorithms, the horizontal gradient image g_{horizontal}(m,n) and the vertical gradient image g_{vertical}(m,n) are first computed using gradient operators. Then, the magnitude gradient image g(m,n) may be computed as follows:

g(m,n)=|g_{horizontal}(m,n)|+|g_{vertical}(m,n)|.

Finally, a thresholding operation is applied to the magnitude gradient image g(m,n) to find edge areas. In other words, pixels whose magnitude gradients exceed a threshhold value are considered as edge areas.

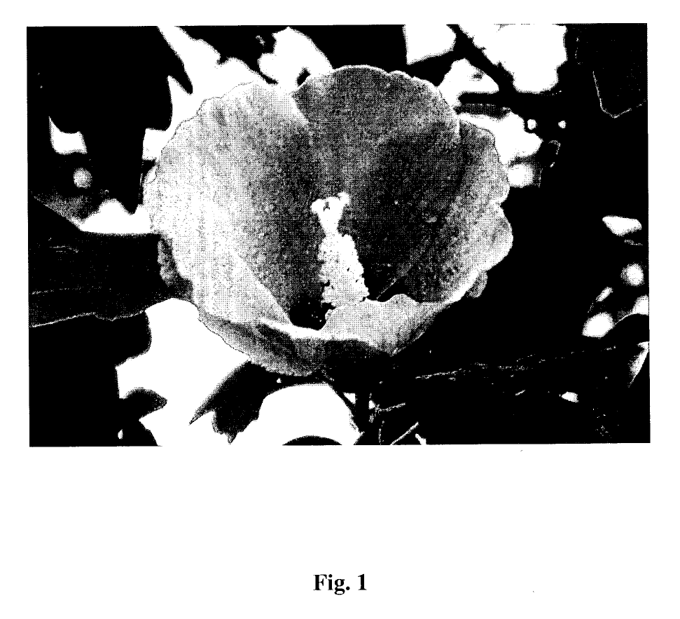

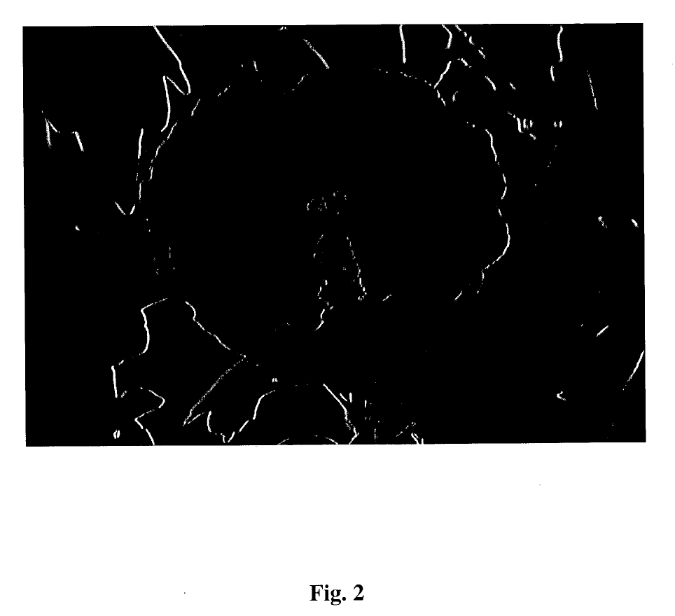

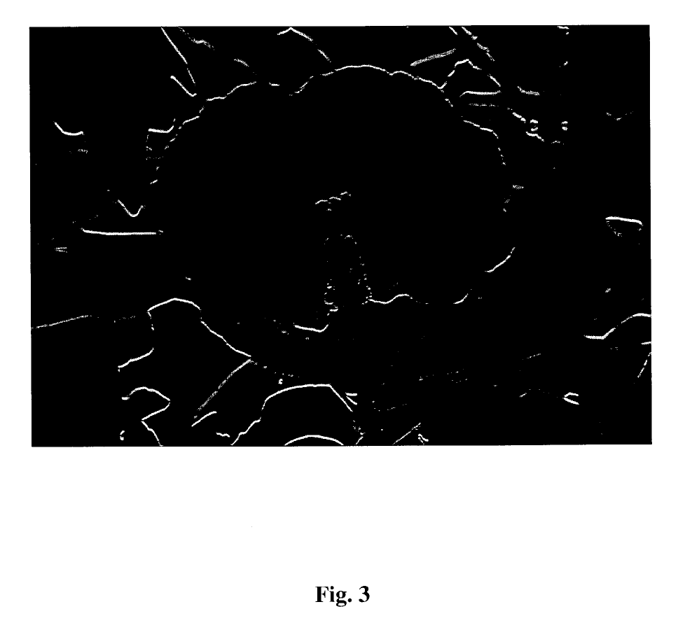

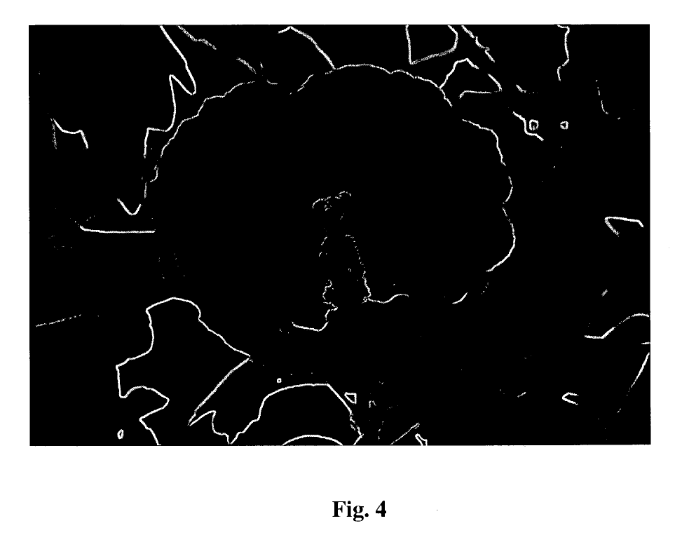

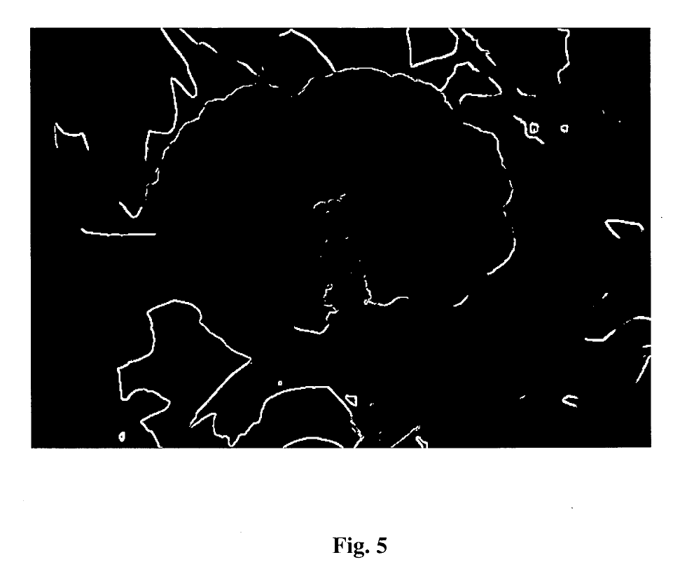

FIGS. 1-5 illustrate the above procedure. FIG. 1 is a source image. FIG. 2 is a horizontal gradient image g_{horizontal}(m,n), which is obtained by applying a horizontal gradient operator to the source image of FIG. 1. FIG. 3 is a vertical gradient image g_{vertical}(m,n), which is obtained by applying a vertical gradient operator to the source image of FIG. 1. FIG. 4 is the magnitude gradient image (edge image) and FIG. 5 is the binary edge image (mask image) obtained by applying thresholding to the magnitude gradient image of FIG. 4.

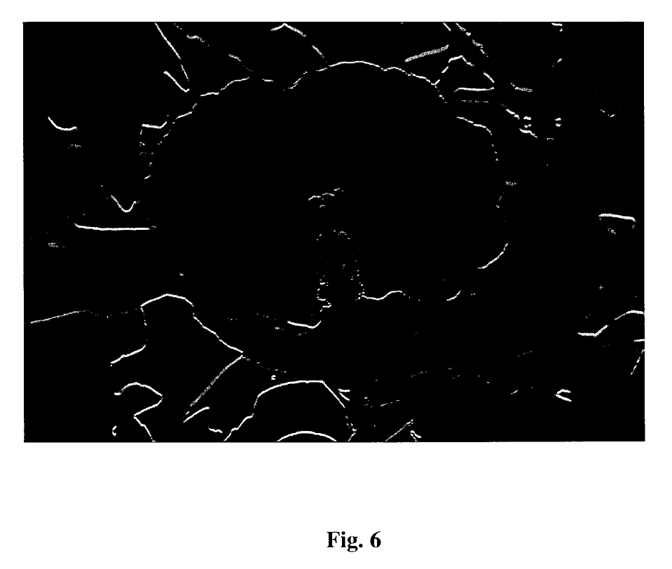

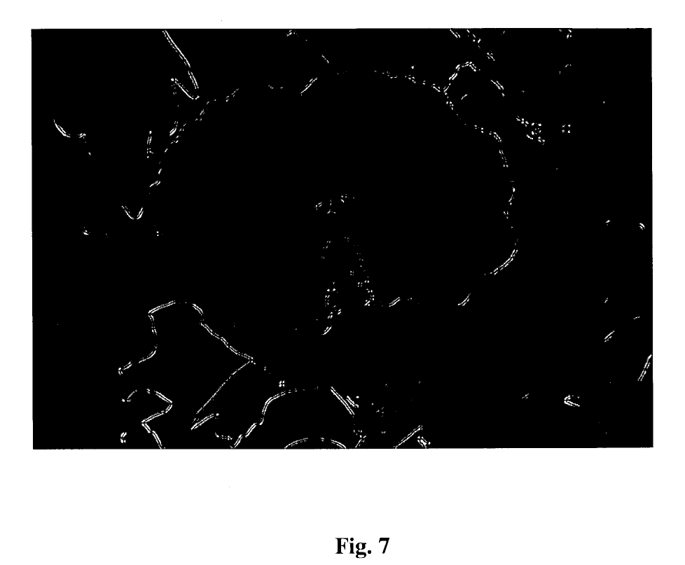

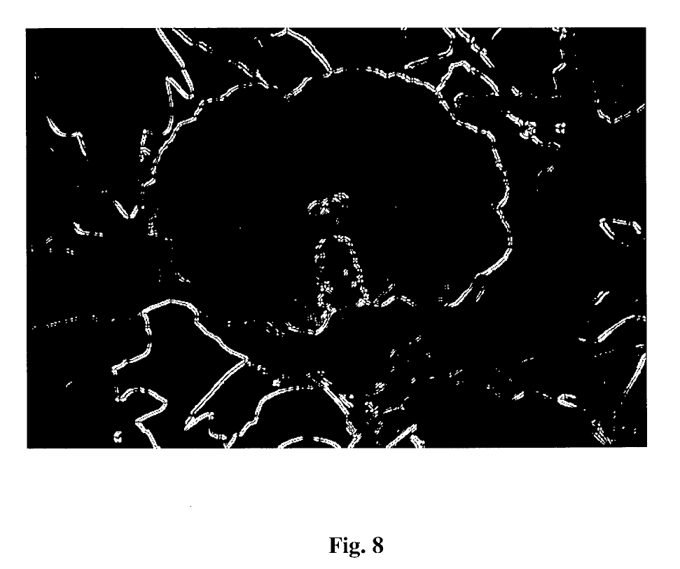

Alternatively, one may use a modified procedure to find edge areas. For instance, one may first apply a vertical gradient operator to the source image, producing a vertical gradient image. Then, a horizontal gradient operator is applied to the vertical gradient image, producing a modified successive gradient image (horizontal and vertical gradient image). Finally, a thresholding operation may be applied to the modified successive gradient image to find edge areas. In other words, pixels of the modified successive gradient image, which exceed a threshhold value, are considered as edge areas. FIGS. 6-9 illustrate the modified procedure. FIG. 6 is a vertical gradient image g_{horizontal}(m,n), which is obtained by applying a vertical gradient operator to the source image of FIG. 1. FIG. 7 is a modified successive gradient image (horizontal and vertical gradient image), which is obtained by applying a horizontal gradient operator to the vertical gradient image of FIG. 6. FIG. 8 is the binary edge image (mask image) obtained by applying thresholding to the modified successive gradient image of FIG. 7.

It is noted that both methods can be understood as an edge detection algorithm. Since the present invention does not specify any particular edge detection algorithm, one may choose any edge detection algorithm depending on the nature of videos and compression algorithms. However, some methods may outperform other methods.

Thus, according to the idea and teaching of the present invention, an edge detection operator is first applied, producing edge images (FIG. 4 and FIG. 7). Then, a mask image (binary edge image) is produced by applying thresholding to the edge image (FIG. 5 and FIG. 8). In other words, pixels of the edge image whose value is smaller than threshold tₑ are set to zero and pixels whose value is equal to or larger than the threshold are set to a nonzero value. FIG. 5 and FIG. 8 show examples of mask images. It is noted that this edge detection algorithm is applied to the source image. Although one may apply the edge detection algorithm to processed images, it is more accurate to apply it to the source images. However, depending on applications, one may apply the edge detection algorithm to the processed images. Since a video can be viewed as a sequence of frames or fields, the above-stated procedure can be applied to each frame or field of videos. Since the present invention can be used for field-based videos or frame-based videos, the terminology “image” will be used to indicate a field or frame.

Next, differences between the source video sequence and processed video sequence corresponding to non-zero pixels of the mask image are computed. In other words, the squared error of edge areas of the l-th frame is computed as follows:

$${se}_{e}^{l} = {\sum }_{i = 1}^{M} {\sum }_{j = 1}^{N} {\{ {S}^{l} ( i , j ) - {P}^{l} ( i , j ) \}}^{2} if \vert {R}^{l} ( i , j ) \vert \neq 0 \qquad ( 1 )$$

where S^{l}(i,j) is the l-th image of the source video sequence, P^{l}(i,j) is the l-th image of the processed video sequence, R^{l}(i,j) is the l-th image of the mask video sequence, M is the number of rows, and N is the number of columns. When the present invention is implemented, one may skip the generation of the mask video sequence. In fact, without creating the mask video sequence, the squared error of edge areas of the l-th frame is computed as follows:

$${se}_{e}^{l} = {\sum }_{i = 1}^{M} {\sum }_{j = 1}^{N} {\{ {S}^{l} ( i , j ) - {P}^{l} ( i , j ) \}}^{2} if \vert {Q}^{l} ( i , j ) \vert \geq {t}_{e} \qquad ( 2 )$$

where S^{l}(i,j) is the l-th image of the source video sequence, P^{l}(i,j) is the l-th image of the processed video sequence, Q^{l}(i,j) is the l-th image of the edge video sequence, tₑ is a threshold, M is the number of rows, and N is the number of columns. Although the mean squared error is used in equation (1) to compute the difference between the source video sequence and the processed video sequence, any other type of difference may be used. For instance, the absolute difference may be also used.

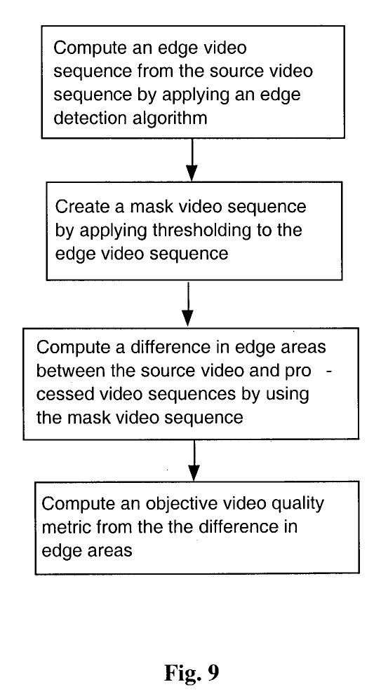

This procedure is repeated for the entire video and the edge mean squared error is computed as follows:

$${mse}_{e} = \frac{1}{K} {\sum }_{l = 1}^{L} {se}_{e}^{l}$$

where K is the total number of pixels of the edge areas. Finally, the PSNR of the edge areas is computed as follows:

$$EPSNR = 10 {log}_{10} ( \frac{{P}^{2}}{{mse}_{e}} ) \qquad ( 3 )$$

where P is the peak pixel value. According to the idea and teaching of the present invention, this edge PSNR (EPSNR) is used as an objective video quality metric. FIG. 9 shows a block diagram of the present invention.

It is apparent that a different threshold will produce a different edge PSNR. Therefore, it is important to choose the optimal value of the threshold. One may try various threshold values and choose the one that provides the best performance in a training video data set. It is observed that a relatively large threshold value tends to provide better performance. It is also observed that the modified edge detection algorithm provides improved performance.

Embodiment 2

Most color videos can be represented by using three components. A number of methods have been proposed to represent color videos, which include RGB, YUV and YCᵣC_{b} [2]. The YUV format can be converted to the YCᵣC_{b} format by scaling and offset operations. Y represents the grey level component. U and V (Cᵣ and C_{b}) represent the color information. In case of color videos, the procedure described in Embodiment 1 may be applied to each component and the average may be used as an objective video quality metric. Alternatively, the procedure described in Embodiment 1 may be applied only to a dominant component, which provides the best performance, and the corresponding edge PSNR may be used as an objective video quality metric.

As another possibility, one may first compute the edge PSNR of a dominant component and use the other two edge PSNRs to slightly adjust the edge PSNR of the dominant component. For example, if the edge PSNR of the dominant component is EPSNR_{dominant}, the objective video quality metric is computed as follows:

VQM=EPSNR_{dominant}+f(EPSNR_{comp 2}, EPSNR_{comp 3})

where EPSNR_{comp 2} and EPSNR_{comp 3} are the edge PSNRs of the other two components, and f(x,y) is a function. A simple function for f(x,y) would be a linear function as follows:

VQM=EPSNR_{dominant}+αEPSNR_{comp 2}+βEPSNR_{comp 3}

where α and β are constants, which is to be determined from training video data. Alternatively, the objective video quality metric is also computed as follows:

VQM=EPSNR_{dominant}+f(EPSNR_{dominant}, EPSNR_{comp 2}, EPSNR_{comp 3}).

In most video compression standards (MPEG 1, MPEG 2, MPEG 4, H.26x, etc.), color videos are represented in the YCᵣC_{b} format. It is observed that for color videos, the edge PSNR computed using the Y-component provides the best performance. In other words, Y is a dominant component. Thus, one can use the edge PSNR computed using only the Y-component as the objective video quality metric (VQM). Alternatively, one can compute the edge PSNRs of the Y-component, Cᵣ-component, and C_{b}-component. Then, the VQM is computed as a linear combination of the three edge PSNRs with more weight for the Y-component. If training video sequences are available, an optimal weight vector can be computed using an optimization procedure.

Embodiment 3

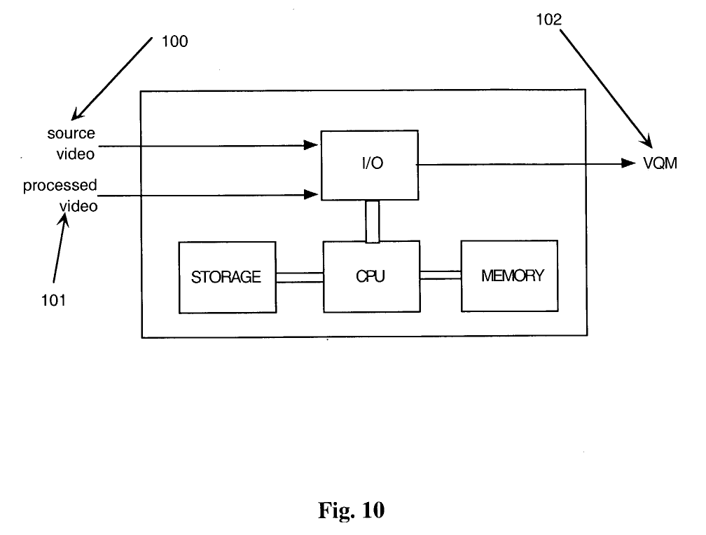

FIG. 10 illustrates a system that measures video quality of a processed video. The system takes two input videos: a source video 100 and a processed video 101. If the input videos are analog signals, the system will digitize them, producing both source and processed video sequences. Then, the system computes an objective video quality metric using the methods described in the previous embodiments and output the objective video quality metric 102.

Embodiment 4

The methods described in the previous Embodiments can be used to optimize the parameters of video codec. Presently, the parameters of video codec are optimized using the conventional PSNR. However, by using the methods described in the previous Embodiments, one can optimize the parameters of video codec so that the resulting video would be better perceived by the human visual system.

### REFERENCES

[1] A. K. Jain, “Fundamentals of digital image processing,” Prentice-Hall, Inc., Englewood Cliffs, N.J., 1989.

[2] K. R. Rao and J. J. Hwang, “Techniques and Standards for Image, Video, and Audio Coding,” Prentice-Hall, Inc., Upper Saddle River, N.J., 1996.

What is claimed is:

1. A method for objective measurement of video quality based on degradation in edge areas, comprising the steps of:
(a) creating an edge video sequence by applying an edge detection algorithm to each image of a source video sequence;
(b) computing a total difference in edge areas between said source video sequence and a processed video sequence by computing differences of pixels that correspond to pixels in said edge video sequence, which are equal to or larger than a threshold;
(c) computing an average difference in edge areas between said source video sequence and said processed video sequence by dividing said total difference in edge areas by the total number of pixels in said edge video sequence, which are equal to or larger than said threshold; and
(d) computing an objective video quality metric which is a function of said average difference in edge areas.

2. The method of claim 1, wherein said edge detection algorithm comprises gradient operators.

3. A method for objective measurement of video quality based on degradation in edge areas, comprising the steps of:
(a) creating an edge video sequence by applying an edge detection algorithm to each image of a source video sequence;
(b) creating a mask video sequence by applying a thresholding operation to each image of said edge video sequence;
(c) computing a total difference in edge areas between said source video sequence and a processed video sequence by computing differences of pixels that correspond to nonzero valued pixels of said mask video sequence;
(d) computing an average difference in edge areas between said source video sequence and said processed video sequence by dividing said total difference in edge areas by the total number of nonzero valued pixels of said mask video sequence; and
(e) computing an objective video quality metric which is a function of said average difference in edge areas.

4. The method of claim 3, wherein said edge detection algorithm comprises gradient operators.

5. The method of claim 3, wherein, in said thresholding operation, pixels whose values are equal to or larger than a threshold are set to a non-zero value and pixels whose values are smaller than said threshold are set to zero.

6. A method for objective measurement of video quality based on degradation in edge areas, comprising the steps of:
(a) creating a vertical edge video sequence by applying a vertical edge detection algorithm to each image of a source video sequence;
(b) creating a horizontal and vertical edge video sequence by applying a horizontal edge detection algorithm to each image of said vertical edge video sequence;
(c) computing a total difference in edge areas between said source video sequence and a processed video sequence by computing differences of pixels that correspond to pixels in said horizontal and vertical edge video sequence, which are equal to or larger than a threshold;
(d) computing an average difference in edge areas between said source video sequence and said processed video sequence by dividing said total difference in edge areas by the total number of pixels in said edge video sequence, which are equal to or larger than said threshold; and
(e) computing an objective video quality metric which is a function of said average difference in edge areas.

7. The method of claim 6, wherein said edge horizontal detection algorithm comprises a gradient operator.

8. The method of claim 6, wherein said edge vertical detection algorithm comprises a gradient operator.

9. A method for objective measurement of video quality based on degradation in edge areas, comprising the steps of:
(a) creating an vertical edge video sequence by applying a vertical edge detection algorithm to each image of a source video sequence;
(b) creating a horizontal and vertical edge video sequence by applying a horizontal edge detection algorithm to each image of said vertical edge video sequence;
(c) computing a total difference in edge areas between said source video sequence and a processed video sequence by computing differences of pixels that correspond to pixels of said horizontal and vertical edge video sequence, which are equal to or larger than a threshold;
(d) computing an average difference in edge areas between said source video sequence and said processed video sequence by dividing said total difference in edge areas by the total number of pixels in said edge video sequence, which are equal to or larger than said threshold; and
(e) computing an objective video quality metric which is a function of said average difference in edge areas.

10. The method of claim 9, wherein said edge horizontal detection algorithm comprises a gradient operator.

11. The method of claim 9, wherein said edge vertical detection algorithm comprises a gradient operator.

12. A system for objective measurement of video quality based on degradation of edge areas, comprising:
source video input means that receives a digital source video sequence;
processed video input means that receives a digital processed video sequence;
edge video producing means that produces an edge video sequence by applying an edge detection algorithm to each image of said source video sequence;
total difference computing means that computes a total difference in edge areas between said source video sequence and a processed video sequence by computing differences of pixels that correspond to pixels of said horizontal and vertical edge video sequence, which are equal to or larger than a threshold;
average difference computing means that computes an average difference in edge areas between said source video sequence and said processed video sequence by dividing said total difference in edge areas by the total number of pixels in said edge video sequence, which are equal to or larger than said threshold;
objective video quality metric computing means that computes an objective video quality metric which is a function of said average difference in edge areas; and
output means that outputs said objective video quality metric.

13. The system of claim 12, wherein said edge detection algorithm comprises gradient operators.

14. A system for objective measurement of video quality based on degradation of edge areas, comprising:
source video input means that receives and digitizes analog source video, producing a digital source video sequence;
processed video input means that receives and digitizes analog processed video, producing a digital processed video sequence;
edge video producing means that produces an edge video sequence by applying an edge detection algorithm to each image of said source video sequence;
total difference computing means that computes a total difference in edge areas between said source video sequence and a processed video sequence by computing differences of pixels that correspond to pixels of said horizontal and vertical edge video sequence, which are equal to or larger than a threshold;
average difference computing means that computes an average difference in edge areas between said source video sequence and said processed video sequence by dividing said total difference in edge areas by the total number of pixels in said edge video sequence which are equal to or larger than said threshold;
objective video quality metric computing means that computes an objective video quality metric which is a function of said average difference in edge areas; and
output means that outputs said objective video quality metric.

15. The system of claim 14, wherein said edge detection algorithm comprises gradient operators.
